(19) United States
(12) Patent Application Publication
(10) Pub. No.: US 2004/0012708 A1
(43) Pub. Date: Jan. 22, 2004

(54) Optical prefilter system that provides variable blur

(76) Inventor: Kevin James Matherson, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/198,775

(22) Filed: Jul. 18, 2002

(51) Int. Cl. H04N 5/225

(52) U.S. Cl. 348/342

(57) ABSTRACT

The present disclosure relates to a variable blur optical prefilter system. In one arrangement, the optical prefilter system comprises a low pass filter that provides varying blur as a function of the distance between the filter and an image plane, and an axial displacement mechanism configured to axially displace the filter along an optical axis of the system toward and away from the image plane. The filter can comprise a phase-noise low pass filter that includes a substrate and a plurality of phase spots associated with a surface of the substrate.

### BACKGROUND

Digital cameras have become quite popular in recent years due to the flexibility of use they provide. Digital still or video cameras comprise one or more solid-state imaging sensing devices such as a charge-coupled device (CCD) or a metal oxide semiconductor (MOS) imaging device. These sensing devices are typically composed of a plurality of small sensing elements that are provided in an array. Each sensing element is capable of capturing, i.e., sampling, a fraction of the entire scene that is to be captured. Because there is a finite number of sensing elements in any sensing device and since each element is necessarily separated from the next by a given, albeit small, distance or pitch, it is not possible to exactly reproduce the viewed scene. Where the scene comprises features that have a higher spatial frequency than the sampling frequency, undersampling occurs. The highest frequency that can be faithfully reconstructed is one-half the sampling frequency. This frequency is known as the Nyquist frequency, f_{N}. Any frequency above the Nyquist frequency is aliased down to a lower frequency. That is, an undersampled signal appears as a lower frequency feature, thereby introducing artifacts of the high frequency features. These artifacts can create false signals as well as form moiré patterns for periodic targets. Once this aliasing occurs, the original scene can never be recovered.

Due to the problems associated with undersampling, prefilters are normally used to limit the band of frequencies that arrive at the sensing device. Generally speaking, ideal prefilters attenuate all frequencies above the Nyquist frequency. There are several methods with which such optical band limiting can be achieved. Although each of these methods degrade the captured image by reducing image sharpness, a trade-off between image sharpness and image accuracy may be achieved that yields acceptable results.

Most commonly, optical band limiting is obtained by inserting a birefringent filter between the objective system and the sensing device. Normally, such filters are constructed of a birefringent material, e.g., crystalline quartz, that provides a double refraction effect that blurs the image to a degree and attenuates the spatial frequency content of the object scene at frequencies above the Nyquist frequency of the sensing device so that the system is less susceptible to aliasing.

Although effectively providing a means to limit the optical bandwidth or limit high spatial frequencies, birefringent filters have several drawbacks. For one, birefringent filters are complicated to manufacture and therefore tend to be quite expensive. In addition, birefringent filters, once manufactured, can only provide a fixed amount of blur which cannot be varied. This latter drawback is significant in that the amount of blur required for a given scene may depend upon, for example, the aperture used to capture it or the spatial frequency of the features of the scene.

### SUMMARY

The present disclosure relates to a variable blur optical prefilter system. In one arrangement, the optical prefilter system comprises a low pass filter that provides varying blur as a function of the distance between the filter and an image plane, and an axial displacement mechanism configured to axially displace the filter along an optical axis of the system toward and away from the image plane. In some embodiments, the filter can comprise a phase-noise low pass filter that includes a substrate and a plurality of phase spots associated with a surface of the substrate.

The present disclosure also relates to a solid-state imaging system. In one arrangement, the imaging system comprises an objective system, a solid-state sensing device, and a variable blur optical prefilter system that includes a low pass filter that provides varying blur as a function of the distance between the filter and the sensing device and an axial displacement mechanism configured to axially displace the filter along an optical axis of the system toward and away from the sensing device.

### BRIEF DESCRIPTION OF THE DRAWINGS

The components in the drawings are not necessarily to scale, emphasis instead being placed upon clearly illustrating the principles of construction and operation.

FIG. 1 is rear view of a low pass filter.

FIG. 2 is a partial side view of the filter shown in FIG. 1 wherein the filter phase spots are configured as protrusions.

FIG. 3 is a partial side view of the filter shown in FIG. 1 wherein the filter phase spots are configured as depressions.

FIG. 4 is a schematic view of an imaging system comprising a variable blur optical prefilter system.

### DETAILED DESCRIPTION

As identified above, known prefilter systems provide fixed amounts of blur. Accordingly, the blur cannot be adjusted as, for example, the aperture of the solid-state imaging device in which the prefilter system is used is changed. Therefore, a variable blur optical prefilter system is needed that provides this functionality. In order to provide such a system, a prefilter must be selected that can be manipulated so as to provide variable blur. As noted above, birefringent filters cannot provide this functionality in that they only provide fixed amounts of blur. However, other low pass filters can be used to provide a degree of blur that varies with the distance between the filter and the image plane (e.g., sensing device). Hence, if optical prefilter systems comprising a mechanism that is capable of axially displacing a low pass filter having such a characteristic relative to the image plane were provided, variable blur could likewise be provided. The present disclosure is, in one aspect, directed to such systems.

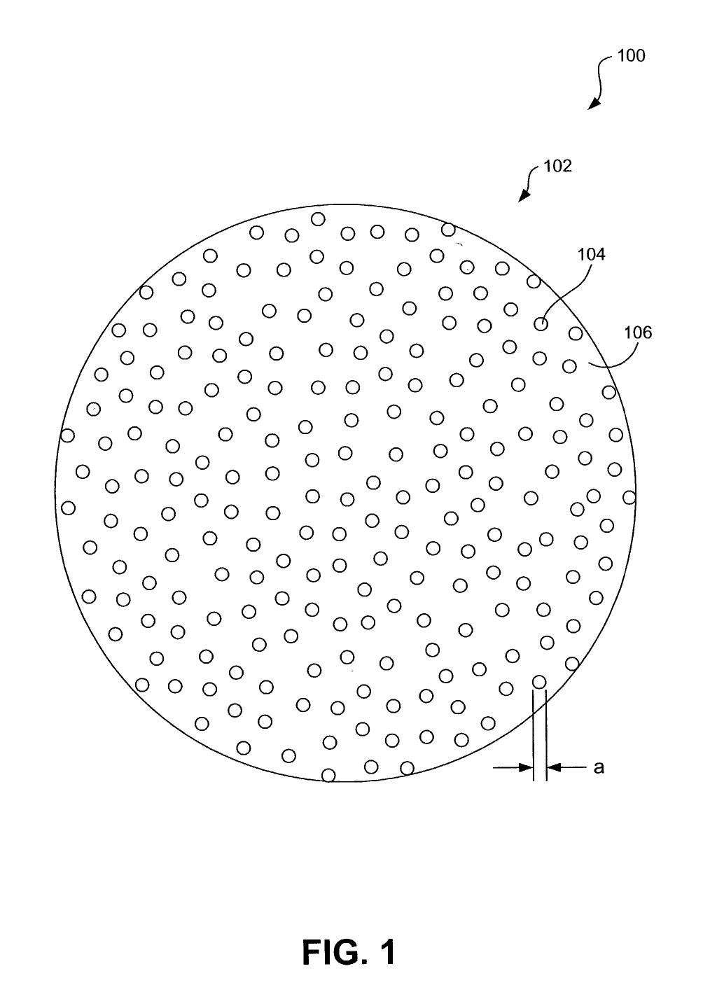

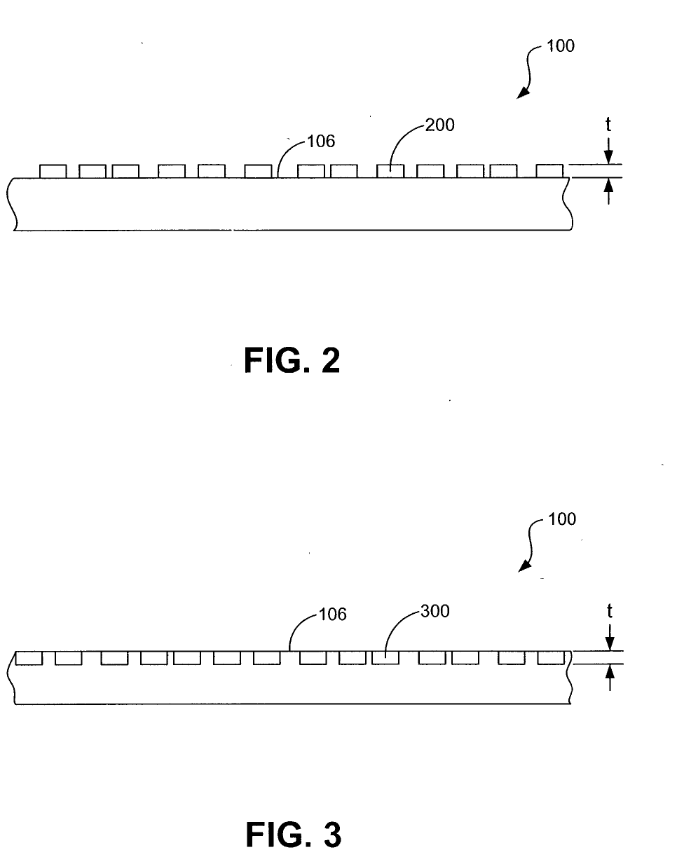

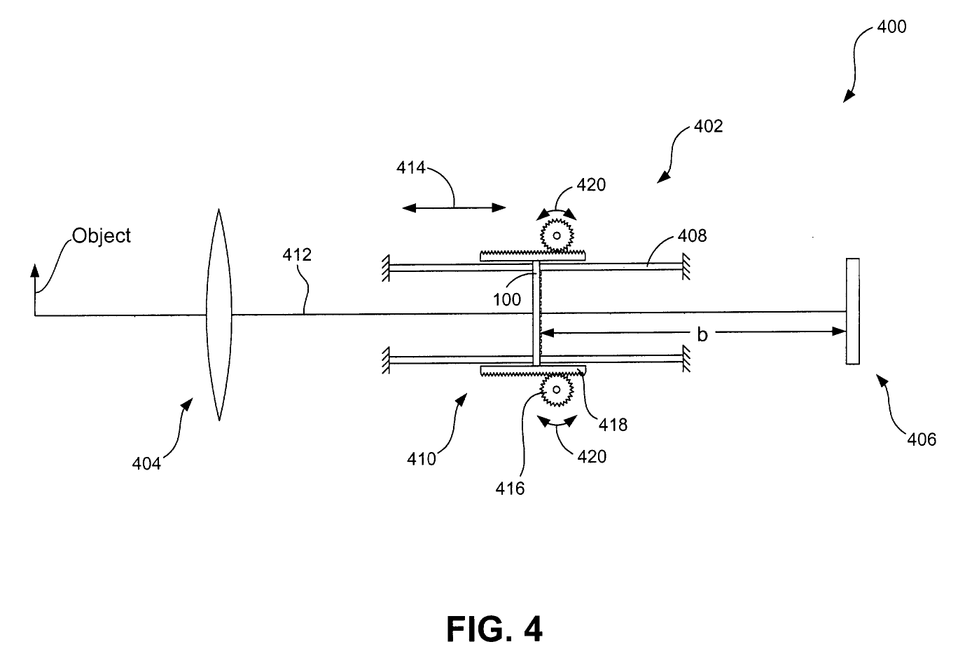

Referring to the drawings, in which like numerals indicate corresponding parts throughout the several views, FIGS. 1-3 illustrate low pass filters 100 that are of the type suitable for use in a variable blur optical prefilter system. In particular, shown in these figures are phase-noise low pass filters. By way of example, U.S. Pat. No. 6,040,857, which is hereby incorporated by reference in its entirety into the present disclosure, describes one such phase-noise low pass filter, as well as its design, in detail. As indicated in FIG. 1, the filter 100 generally comprises a transparent substrate 102 that is provided with a plurality of randomly positioned and mutually spaced transparent phase spots 104 on the surface 106 of the filter. As indicated in the side view of FIG. 2, the phase spots 104 can comprise protrusions 200 that extend from the surface 106. As indicated in the side view of FIG. 3, these phase spots 104 can, alternatively, comprise depressions 300 formed in the filter surface 106. The phase spots 104 each have a thickness (or depth) t that is typically on the order of the wavelength of the light that passes through the filter 100.

Both the substrate 102 and phase spots 104 can be formed of various different materials. By way of example, the filter 100 can be formed using a polymeric material in a master mold used to cast or stamp replicate low pass filters. Alternatively, photoresist can be spin-coated on a glass substrate (e.g., quartz) and the photoresist then photolithographically patterned according to the phase spot pattern that is desired. In such a case, the glass substrate can then be placed in a buffered oxide etch solution that transfers the spot pattern in the photoresist to the substrate 102, and the photoresist then removed. In another alternative, a thin layer of transparent organic polymer, such as polymethylmethacrylate (PMMA), can be deposited onto the transparent substrate 102 and a thin inorganic etch-stop layer, such as silicon dioxide, can be evaporated thereon. After patterning the etch-stop layer with the spot pattern using standard photolithographic processing techniques, the etch-stop pattern can be transferred to the polymer using an oxygen plasma reactive ion etching technique.

As will be appreciated by persons having ordinary skill in the art, the amount of blur that is provided depends, in part, upon the parameters of the filter 100. These parameters include 1) ξ, the fractional area of the surface of the filter that is covered by the transparent spots; 2) t, the physical thickness of the phase spots (assuming that the indexes of refraction of the phase spots and the medium surrounding the phase spots are given); and 3) a, the diameter of the phase spots. It will be appreciated that, in general, the optimum blur filter for use in a solid-state imaging device with discrete sampling should exhibit sufficiently low values of the spectrally averaged high spatial frequency modulation transfer function (MTF) to suppress aliasing artifacts that occur at the lowest spatial frequencies subject to the condition that the MTF of the entire optical system (including the objective lens system and the phase-noise low pass filter 100) be as large as possible for those spatial frequencies below which aliasing artifacts occur. Such a result can be obtained where the phase-noise low pass filter 100 comprises, for example, a ξ value of approximately 0.5, a phase spot thickness t of approximately 0.37 micrometers and a phase spot diameter, a, of approximately 313 micrometers. A detailed discussion of the derivation of these values is provided in U.S. Pat. No. 6,040,857.

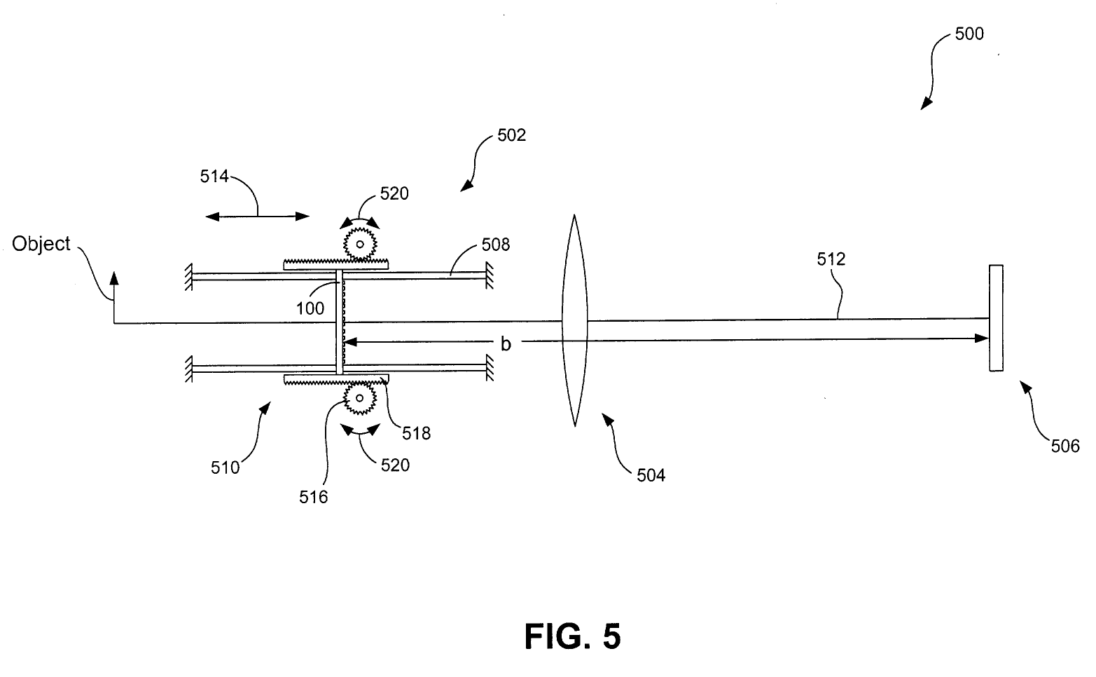

When positioned between an objective lens system and the image plane of an imaging system (see e.g., FIG. 4), or directly in front of the objective lens system, the filter 100 causes aberrations in the wave front of the light passing through it. The MTF due to the filter 100 alone (i.e., excluding the effects of lens aberrations and finite aperture) can be derived from the auto-correlation of the randomly arrayed transparent phase spots 104 where each spot introduces a phase difference φⱼ relative to light passing through the substrate in regions without spots. The MTF at a particular optical wavelength λⱼ, as a function of spatial frequency, is given as follows:

$$MTF ( f , λ ) = \{ 1 - [ 2 ξ ] [ 1 - cos φ ( λ ) ] [ 1 - g ( \frac{λ bf}{2} ) ] \} \qquad [ Equation 1 ]$$

where f is the spatial frequency, ξ is the fractional area of the surface 106 of the filter 100 that is covered by the transparent phase spots 104,

$$φ ( λ ) = 2 π \frac{n ( λ ) - {n}^{′} ( λ )}{λ} t , \qquad [ Equation 2 ]$$

and n(λ) is the index of refraction of the material forming the spots at the specific wavelength λ, n′(λ) is the index of refraction of the medium surrounding the spots at the specific wavelength λ, and t is the physical thickness (or depth) of the phase spots. The function g(λbf/2) is the geometrical auto-correlation of the phase spots along a specific direction and has the properties g(0)=1 and g(λbf/2)=ξ for very large values of the argument λbf/2. The function g depends implicitly on the phase spot diameter a in that the auto-correlation of the phase spots drops off more rapidly with spatial frequency when the phase spot diameter is smaller. The quantity b in Equation 1 is the distance between the spot-bearing surface 106 of the filter 100 and the image plane (e.g., sensing device).

The filter 100 provides a low pass optical band limiting that suppresses aliasing artifacts over a broad spectral range while at the same time causing as little reduction as possible in the system MTF for those spatial frequencies below the Nyquist frequency. More particularly, the filter 100 sufficiently attenuates high spatial frequencies to substantially reduce or eliminate entirely aliasing artifacts for incident light over the entire bandwidth of spectral sensitivity of the imaging system for which the prefilter system is provided. The filter 100 produces a phase difference between a wave front transmitted through the spots and that portion of the substrate other than the spots to define a filter having a spatial sampling cutoff frequency which is approximately independent of the wavelength of light over a specific spectral bandwidth from a lower wavelength λ_{B} to an upper wavelength λ_{R}, the phase difference satisfying the following condition

φ₀=π [Equation 3]

Where φ₀ is the phase difference due to the spots at a certain specific wavelength, λ₀, such that

λ_{B}≦λ₀≦λ_{R} [Equation 4]

And where φ₀ is given by the relationship

$${φ}_{o} = 2 π \frac{{n}_{o} - {n}_{o}^{′}}{{λ}_{o}} t \qquad [ Equation 5 ]$$

so that

$$t = \frac{{λ}_{o}}{2 ( {n}_{o} - {n}_{o}^{′} )} \qquad [ Equation 6 ]$$

where n₀ is the index of refraction of the material forming the spots at the specific wavelength λ₀; n₀′ is the index of refraction of the medium surrounding the spots at the specific wavelength λ₀, and t is the physical thickness of the spots.

The above-described arrangement provides many advantages over prior art prefilters. For instance, as mentioned above, the phase-noise low pass filter 100 can be displaced along the optical axis of the imaging system to vary the distance between the filter and the image plane and thereby vary the amount of blur that is provided. In the case of a phase-noise optical low-pass filter such as filter 100, which uses diffraction to blur the point speed function (PSF), the cutoff frequency of the filter is given by:

$${v}_{cutoff} = \frac{a}{b λ} \qquad [ Equation 7 ]$$

Therefore, if it is desired to attenuate frequencies beyond v cutoff=½Δ, where Δ is the pixel pitch of the solid-state sensing device, the filter-to-sensor spacing, b, can be determined using the relation:

$$b = \frac{2 a Δ}{λ} \qquad [ Equation 8 ]$$

According to this relation, the amount of blur that will be provided at any wavelength increases as the distance b increases and decreases as the distance b decreases.

Other advantages of the phase-noise low pass filter 100 include achieving high attenuation uniformly over substantially all spectral bands, eliminating or reducing aliasing artifacts in two dimensions regardless of the filter orientation with respect to the sensing device, ease of fabrication, no reliance upon materials having unique optical properties, no spurious patterns produced in the image plane as artifacts due to interference generated by regular gratings, etc.

FIG. 4 illustrates an example imaging system 400 that includes a variable blur optical prefilter system 402. The imaging system 400, for instance, can comprise part of a solid-state imaging device such as a digital still or video camera. As indicated in FIG. 4, the imaging system 400 generally comprises an objective system 404 (represented by a single lens) and a solid-state sensing device 406 that can, for instance, comprise a charge-coupled device (CCD) or a metal oxide semiconductor (MOS) imaging device.

The optical prefilter system 402 includes a low pass filter 100 that, for example, comprises a phase-noise low pass filter. The filter 100 is shown slidingly mounted on rails 408 contained within the imaging system 400. In addition, the optical prefilter system 402 can comprise an axial displacement mechanism 410 that can be used to axially displace the filter along the optical axis 412 of the imaging system 400 in the manner indicated by arrow 414 so as to vary the distance b between the filter and the sensing device 406 to thereby vary the amount of blur that is provided to the optical system. As indicated in FIG. 4, the displacement mechanism 410 can, for instance, comprise one or more gears 416 that mesh with one or more racks 418. In the arrangement illustrated in FIG. 4, for example, racks 418 are fixedly connected to the filter 100 (or its housing where applicable) and are driven by axially fixed gears 416 that are, in turn, driven (as indicated by arrows 420) by a motor (not shown) such as a stepper motor, servomotor, or the like. Persons having ordinary skill in the art will appreciate that the displacement mechanism shown in FIG. 4 is provided for purposes of illustration only and that myriad other types of mechanisms could be provided to facilitate displacement of the filter 100 within the imaging system 400.

In use, the axial position of the filter 100 can be adjusted by the user by, for instance, selecting one of several preset blur settings, or can be automatically adjusted by the imaging system 400 in response to predetermined parameters. For example, the axial position of the filter 100 along the optical axis can be changed as a function of the lens aperture setting or the spatial frequency of the object scene. In the former case, the blur provided will increase as the aperture increases. In the latter case, a sensor (not shown) can be used to sense fine, periodic features within the object scene (e.g., narrow slats of a picket fence) and increase blur as needed. Furthermore, blur can be adjusted by the user to suit his or her own preferences. In other cases, the amount of blur can be varied as a function of which parts of the sensing device 406 are actually being read. For instance, higher blur may be acceptable for high frame rate video applications. In any case, the axial position of the filter 100 can be adjusted by the displacement mechanism 410 such that optimal blur is obtained so as to reduce or eliminate distortions caused by aliasing.

FIG. 5 illustrates a further example imaging system 500 that includes a variable blur optical prefilter system. The imaging system 500 is similar to that described above in relation to FIG. 4, however, the image system 500 includes an optical prefilter system 502 that is positioned in object space (i.e., between the object and the objective) as opposed to image space (i.e., between the objective and the sensing device) as in FIG. 4. Accordingly, the imaging system 500 comprises an objective system 504 and a solid-state sensing device 506. As in the system 400, the optical prefilter system 502 includes a low pass filter 100 that, for example, comprises a phase-noise low pass filter. The filter 100 is shown slidingly mounted on rails 508 contained within the imaging system 500. In addition, the optical prefilter system 502 can comprise an axial displacement mechanism 510 that can be used to axially displace the filter along the optical axis 512 of the imaging system 500 in the manner indicated by arrow 514 so as to vary the distance b between the filter and the sensing device 506. As indicated in FIG. 5, the displacement mechanism 510 can, for instance, comprise one or more gears 516 that mesh with one or more racks 518.

While particular embodiments of the invention have been disclosed in detail in the foregoing description and drawings for purposes of example, it will be understood by those skilled in the art that variations and modifications thereof can be made without departing from the scope of the invention as set forth in the following claims. For instance, although phase-noise low pass filters have been described as being used in the variable blur optical prefilter system, persons having ordinary skill in the art will appreciate that alternative low pass filters that provide variable amounts of blur as a function of distance from the image plane may be used.

What is claimed is:

1. A variable blur optical prefilter system, comprising:
a low pass filter that provides varying blur as a function of the distance between the filter and an image plane; and
an axial displacement mechanism configured to axially displace the filter along an optical axis of the system toward and away from the image plane.

2. The system of claim 1, wherein the filter comprises a phase-noise low pass filter.

3. The system of claim 2, wherein the filter comprises a substrate and a plurality of phase spots associated with a surface of the substrate.

4. The system of claim 3, wherein the phase spots comprise protrusions that extend from the substrate surface.

5. The system of claim 3, wherein the phase spots comprise depressions formed in the substrate surface.

6. The system of claim 3, wherein the filter surface has a fractional area of surface covered by phase spots of approximately 0.5, the phase spots have a thickness of approximately 0.37 micrometers, and the phase spots have a diameter of approximately 313 micrometers.

7. The system of claim 1, wherein the filter comprises a polymeric material.

8. The system of claim 1, wherein the filter comprises a glass material.

9. The system of claim 1, wherein the filter comprises polymethylmethacrylate.

10. The system of claim 1, wherein the axial displacement mechanism is motorized.

11. The system of claim 1, wherein the mechanism is actuated in response to user selections.

12. The system of claim 1, wherein the axial displacement mechanism is automatically actuated as a function of an aperture setting.

13. The system of claim 1, wherein the axial displacement mechanism is automatically actuated as a function of sensed spatial frequency of an object scene to be captured.

14. The system of claim 1, wherein the axial displacement mechanism is automatically actuated as a function of frame rate.

15. The system of claim 1, further comprising an objective system and a sensing device and wherein the low pass filter is positioned between the objective system and the sensing device.

16. The system of claim 1, further comprising an objective system and wherein the low pass filter is positioned between an object and the objective system.

17. A solid-state imaging system, comprising:
an objective system;
a solid-state sensing device; and
a variable blur optical prefilter system that includes a low pass filter that provides varying blur as a function of the distance between the filter and the sensing device and an axial displacement mechanism configured to axially displace the filter along an optical axis of the system toward and away from the sensing device.

18. The imaging system of claim 17, wherein the filter comprises a phase-noise low pass filter.

19. The imaging system of claim 18, wherein the filter comprises a substrate and a plurality of phase spots associated with a surface of the substrate.

20. The imaging system of claim 19, wherein the phase spots comprise protrusions that extend from the substrate surface.

21. The imaging system of claim 19, wherein the phase spots comprise depressions formed in the substrate surface.

22. The imaging system of claim 17, wherein the axial displacement mechanism is motorized.

23. The imaging system of claim 17, wherein the mechanism is actuated in response to user selections.

24. The imaging system of claim 17, wherein the axial displacement mechanism is automatically actuated as a function of an aperture setting.

25. The imaging system of claim 17, wherein the axial displacement mechanism is automatically actuated as a function of sensed spatial frequency of an object scene to be captured.

26. The imaging system of claim 17, wherein the axial displacement mechanism is automatically actuated as a function of frame rate.

27. The imaging system of claim 17, wherein the variable blur optical prefilter system is positioned between the objective system and the solid-state sensing system.

28. The imaging system of claim 17, wherein the variable blur optical prefilter system is positioned between an object and the objective system.

29. A method for providing variable blur in an imaging system, comprising:
providing a low pass filter that provides varying blur as a function of the distance between the filter and an image plane;
providing an axial displacement mechanism that is configured to axially displace the filter; and
manipulating the axial displacement mechanism such that the distance between the filter and the image plane is varied to thereby vary the amount of blur that is provided by the filter.

30. The method of claim 29, wherein the filter is a phase-noise low pass filter.
